(19) United States
(12) Patent Application Publication
(10) Pub. No.: US 2025/0232257 A1
(43) Pub. Date: Jul. 17, 2025

(54) SYSTEM FOR EXTRACTING DATA FROM A DRAWING BOM AND RELATED METHODS

(71) Applicant: BOM Tabulator LLC, Winter Garden, FL (US)

(72) Inventors: JAMES NELSON, WINTER GARDEN, FL (US); TED VAN WINKLE, WINTER GARDEN, FL (US)

(21) Appl. No.: 19/018,461

(22) Filed: Jan. 13, 2025

Related U.S. Application Data
(60) Provisional application No. 63/620,293, filed on Jan. 12, 2024.

(51) Int. Cl. G06Q 10/0875; G06V 30/16

(52) U.S. Cl. CPC G06Q 10/0875; G06V 30/16

(57) ABSTRACT

A system is for extracting data from a drawing BOM. The system includes a processor configured to receive the initial drawing, process the initial drawing to generate extracted values, and assign a part number to each of the extracted values. The processor is also configured to generate a material list based upon the part numbers for the extracted values, generate area values and mass values for the material list, generate a value for stock material from the initial drawing, and output a listing for the BOM based upon the material list and the value for stock material.

### RELATED APPLICATION

This application is based upon prior filed copending Application No. 63/620,293 filed Jan. 12, 2024, the entire subject matter of which is incorporated herein by reference in its entirety.

### TECHNICAL FIELD

The present disclosure relates to the field of manufacturing, and, more particularly, to a system for extracting data from a drawing bill of materials, drawing views, and related methods.

### BACKGROUND

In the global economy, American manufacturing is commonly sourced overseas to reduce labor costs. Nonetheless, approximately 10,000 small metal fabricators remain in the United States to support key industries, such as space, defense, and construction. Examples of these small fabrication shops include machining, welding, sheet metal, and developmental shops. These shops provide custom fabrication to support launch operations, load and functional testing, tooling, development, optical, communication, and surveillance equipment. While costly, American manufacturers have efficiencies, shipping processes, and skill sets that cannot be matched overseas.

Upon initiation of a manufacturing job, one of the preliminary tasks is to extract information from a drawing package to determine the quantity of stock material, fasteners, parts, and paint to purchase. This is known as the “Bill of Materials” (BOM). Another preliminary task is determining how to route labor through the various manufacturing processes and deliver the completed parts while complying with customer deadlines. This is known as the “Routing”. The process of extracting data for these two items is called a “Drawing Takeoff”. This task is assigned to project managers and engineers, which can be costly.

### SUMMARY

Generally, a system is for extracting a BOM from an initial drawing. The system comprises a processor and memory associated therewith and configured to receive the BOM in the initial drawing, process the BOM in the initial drawing to extract the data listed for every component from the BOM and assign it a specific number and category. The processor then generates several lists from the data including the linear material procurement list, the plate and sheet procurement list, the purchase component list, and the fastener procurement list. For the linear material, the processor generates a cut list that optimizes the cutting order required from the minimal number of lengths to be ordered. For raw sheet or plate, the processor optimizes the cutting configuration to get all sizes required from the minimum sheet or plate required. The processor also calculates the mass (or weight) of raw material to be ordered to be used for costing or other associated calculations.

Another aspect is directed to a method for generating a BOM for an initial drawing. The method comprises receiving the initial drawing, processing the initial drawing to generate a plurality of extracted values, assigning a part number to each of the plurality of extracted values, and generating a material list based upon the part numbers for the plurality of extracted values. The method also includes generating a plurality of area values and a plurality of mass values for the material list, generating a value for stock material from the initial drawing, and outputting a listing for the BOM based upon the material list and the value for stock material.

### BRIEF DESCRIPTION OF THE DRAWINGS

FIG. 1 is a schematic diagram of a system, according to the present disclosure.

FIG. 2A is a typical overall assembly drawing with a typical multi component BOM. FIG. 2D is a typical subassembly with a typical multi component BOM. FIG. 2B is a typical weldment with a typical multi component BOM. FIG. 2B, 2C, and-2F are typical piece part drawings with typical BOMs that have only a single component or one line.

FIGS. 3-6 are images of the software graphics user interface in the system of FIG. 1.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

In the typical Drawing Takeoff approach, the process is largely manual and includes the following steps: manually typing out all data; manually calculating required part quantities; generating data based off the initial drawing so errors are the fault of the customer and not the manufacturer; and manually combining all identical plate/sheet, structural shapes, purchase parts etc. One approach to manual Drawing Takeoff is to generate it via a three-dimensional (3D) model, but this approach is limited to applications with compatible 3D files formats.

The present disclosure provides a software application that reduces time for the Drawing Takeoff process by an estimated 70%. Taking this time reduction into consideration, this has the potential to reduce overall manufacturing costs by up to 10% as well as improve lead time by up to 10%.

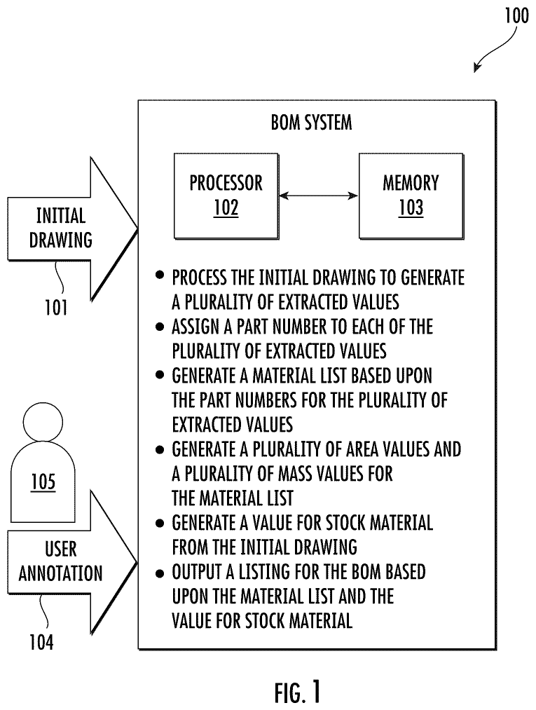

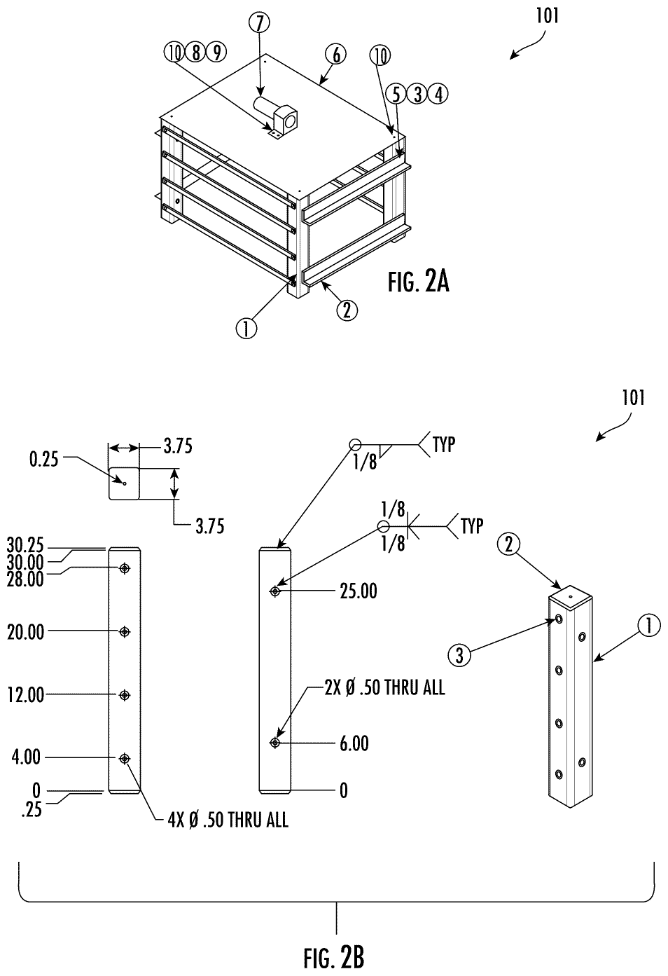

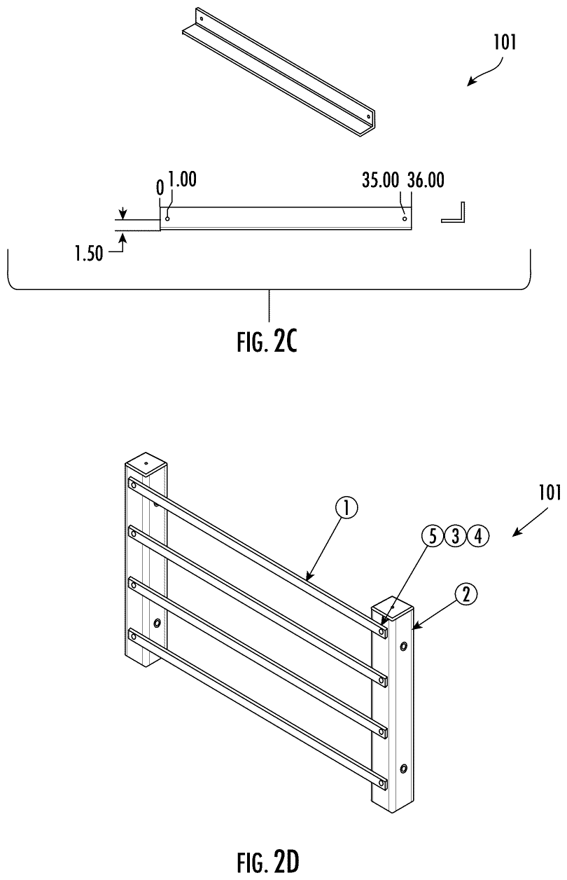

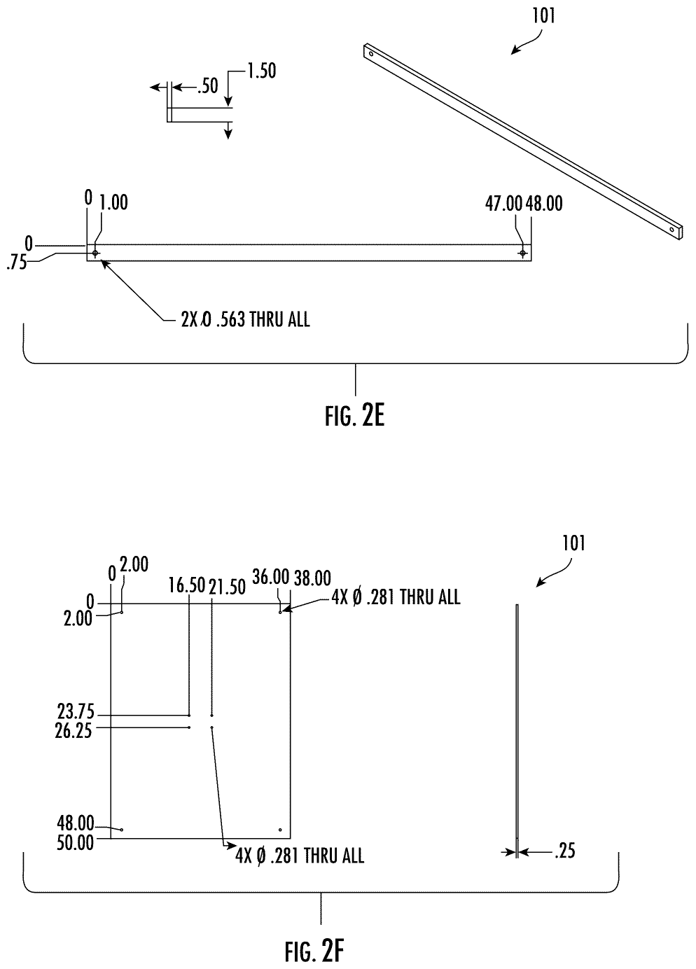

Referring initially to FIG. 1 & FIGS. 2A-2F, a system 100 according to the present disclosure is now described. The system 100 is for extracting data from a drawing BOM 101. (e.g., PDF drawings in blueprint package including a plurality of sheets). For example, the initial drawings 101 depicted in FIGS. 2A-2F include multiple sheets. As will be appreciated, the BOM may comprise a list of quantities of the following types: dependent parts, details found in other PDF drawings in blueprint package; purchase parts, motors, gears, etc.; fasteners, bolts, nuts, etc.; structural Shape Stock, I-Beam, Tubing, Bar, etc.; cut to custom length and mitered to custom angle; and plate/sheet stock, cut to custom length and width ordered to desired thickness (usually sheared, waterjet, laser cut).

The system 100 illustratively includes a processor 102 and memory 103 associated therewith and configured to receive the initial drawing 101, process the initial drawing to extract the data listed for every component from the BOM and assign it a specific number and category. The processor 102 is also configured to generate a material list based upon the part numbers for the plurality of extracted values, and generate a plurality of area values and a plurality of mass values for the material list. Also, the processor 102 is configured to generate a value for stock material from the initial drawing 101.

In some embodiments, the processor 102 is configured to receive annotations input 104 from a user 105 related to one or more of the plurality of extracted values, the assigned part numbers, the material list, and the plurality of area values and the plurality of mass values for the material list. In particular, the user 105 searches through the initial drawing 101 and identifies all BOMs in part drawings. The processor 102 is configured to scan in all text directly from the initial drawing 101 and tabulates data, and the user 105 identifies headers on a BOM table. The user 105 maps columns to identify parts, quantities, material, and other metadata. The processor 102 is configured to sum up the required quantities. The user 105 assigns each row as a data type: structural shape, plate/sheet, purchase part and fastener, and the user provides any supplemental information required for procurement. The processor 102 is configured to calculate weight and surface area of each part, and calculate estimated paint usage of each part.

The processor 102 is also configured to output a listing for the BOM based upon the material list and the value for stock material. The listing may comprise a reformatted BOM list, an indented BOM List (i.e., a drawing tree); a part list (i.e., a quantity of each part required to complete job); a purchase list including quantity of stock lengths of structural shapes, quantity of stock plates/sheet, and quantity of purchase parts/fasteners needed; a purchase part and fastener kitting lists and labels (i.e., how to separate and organize purchase parts and fasteners upon receipt); plate nesting lists (i.e., how to efficiently cut plate to order the minimum required); structural shape nesting lists (i.e., how to efficiently cut structural shapes to order the minimum required); paint lists (uses square footage and paint information to estimate gallons of paint); and shipping lists (uses weight and size information to create shipping documents).

Another aspect is directed to a method for extracting data from a drawing BOM 101. The method comprises receiving the initial drawing 101, processing the initial drawing to generate a plurality of extracted values, assigning a part number to each of the plurality of extracted values, and generating a material list based upon the part numbers for the plurality of extracted values. The method also includes generating a plurality of area values and a plurality of mass values for the material list, generating a value for stock material from the initial drawing, and outputting a listing for the BOM based upon the material list and the value for stock material.

Referring now to FIG. 3, the step of the user 105 selecting tables is described with reference to a graphics user interface (GUI) 106. The GUI 106 illustratively includes a part number selection menu 107 where the user 105 identifies the part as “Assem2”, and a table selection menu 110 where the user selects the scan table. The processor 102 is configured to preprocess the images of the initial drawings 101. In some embodiments, the processor 102 may use a real-time optimized Computer Vision library/tool to preprocess the images, and may use optical character recognition (OCR) to identify the table. The GUI 106 illustratively includes a read table menu 111 where if ASCII text is available (i.e., a text rendered file), the PyMuPDF (i.e., a high-performance Python library for data extraction, analysis, conversion & manipulation of PDF) extracts the BOM data. If ASCII text is unavailable (e.g., an unscanned PDF file or flattened), an OCR tool may extract the BOM data. The user 105 would then scan in additional drawings for processing.

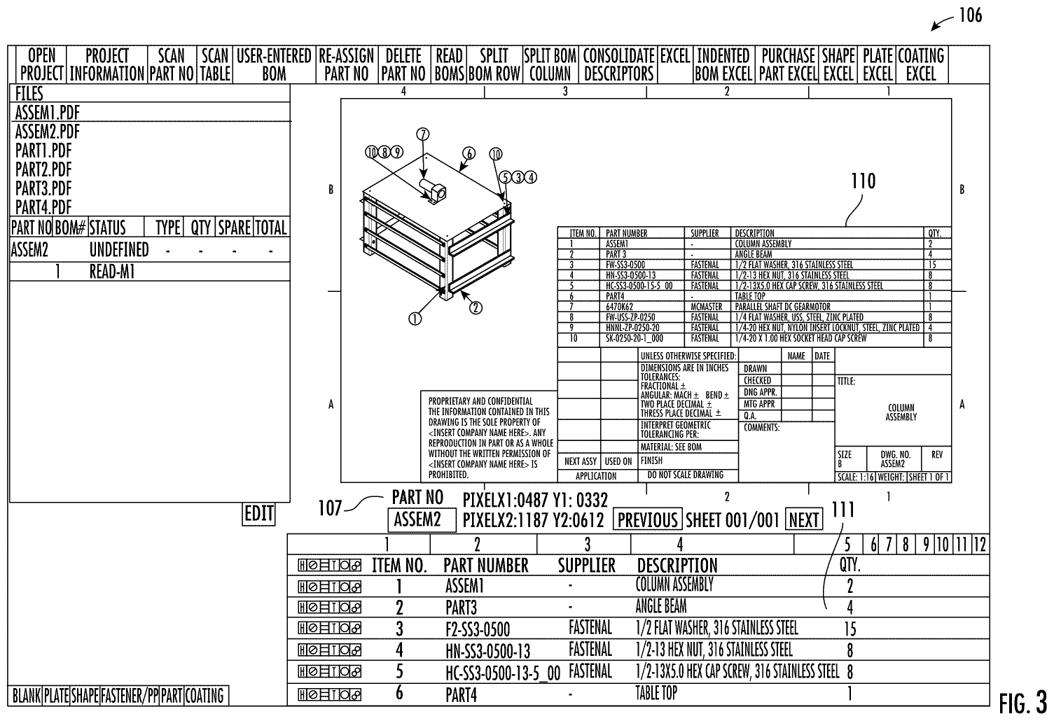

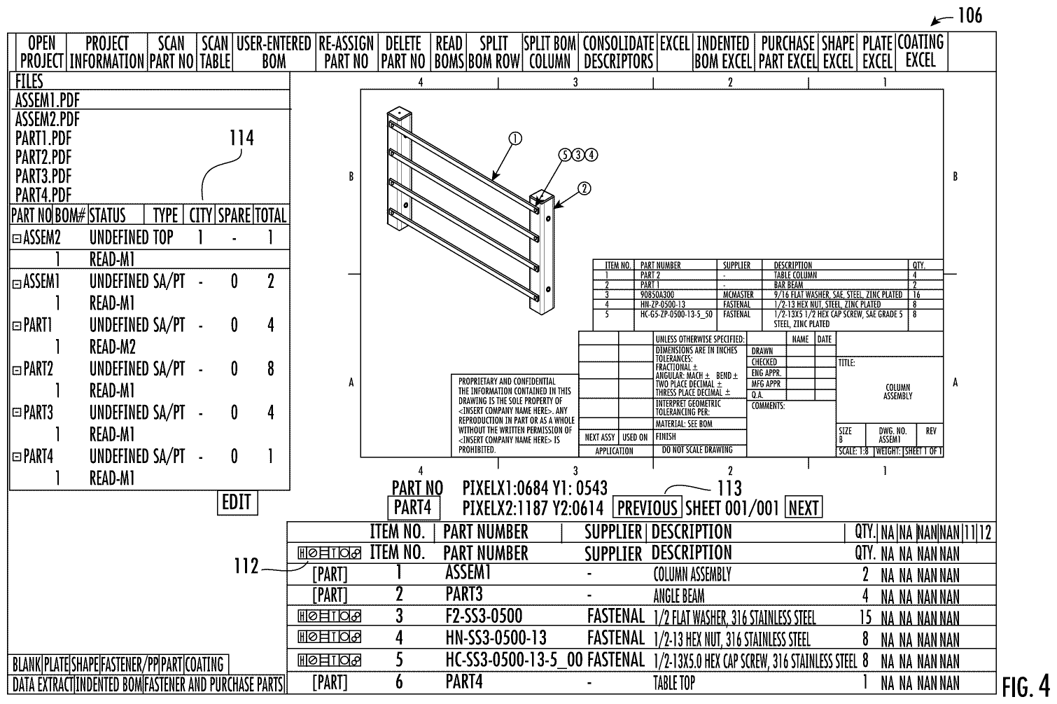

Referring now to FIG. 4, the step of the user 105 selecting tables and mapping columns is described with reference to the GUI 106. The GUI 106 illustratively includes a header menu 112 for identifying the header. The header will appear at the top of the table. The GUI 106 illustratively includes a column menu 113 for mapping the column. This identifies columns for the program, for example, which column represents quantity. After the critical maps have been completed, the algorithm creates a drawing tree 114 in the GUI 106 and sums up the required quantities of each part. Here, Assem2 has been identified as the top level. This will be quantity of 1 unless the user requests more. Assem1 is a subassembly/part, and it will be driven by Assem2. The user 105 enters a number of spares needed for this part. The other parts are driven similarly. This is all done with a GUI library within custom software algorithms.

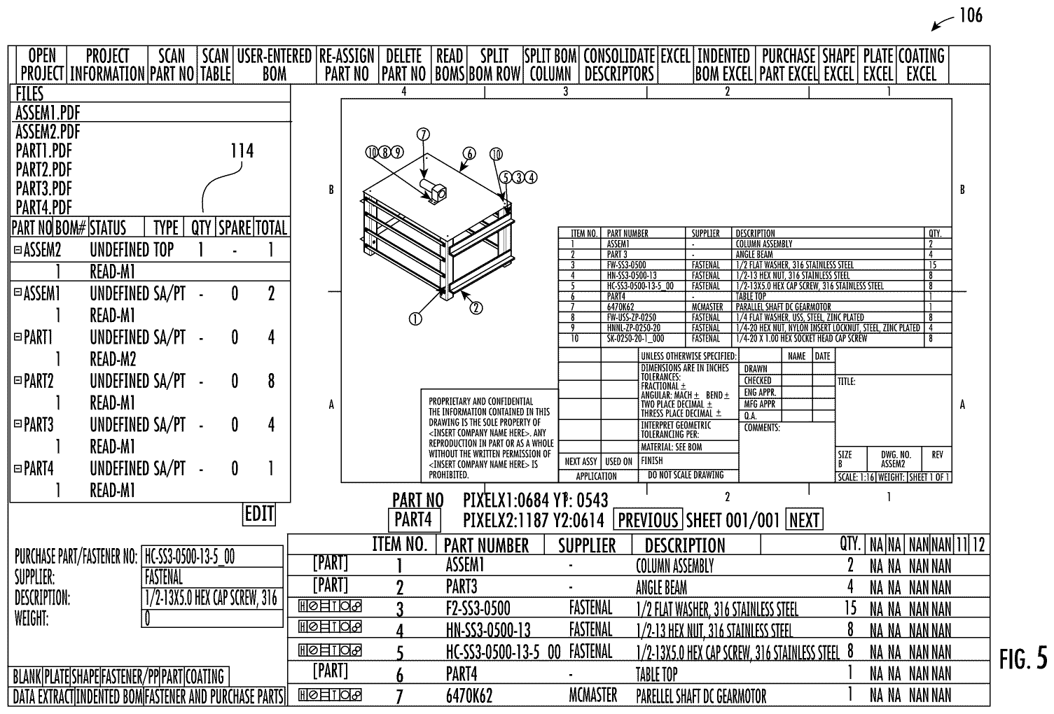

Referring now to FIG. 5, the step of the user 105 defining each row is described with reference to the GUI 106. Here, the user 105 defines each row by at least selecting on the assignment tiles at the left of the table. A purchase part/fastener requires a supplier, and part number is to be defined. Structural shapes and plates are more complicated but require similar fields. This is done with custom algorithms.

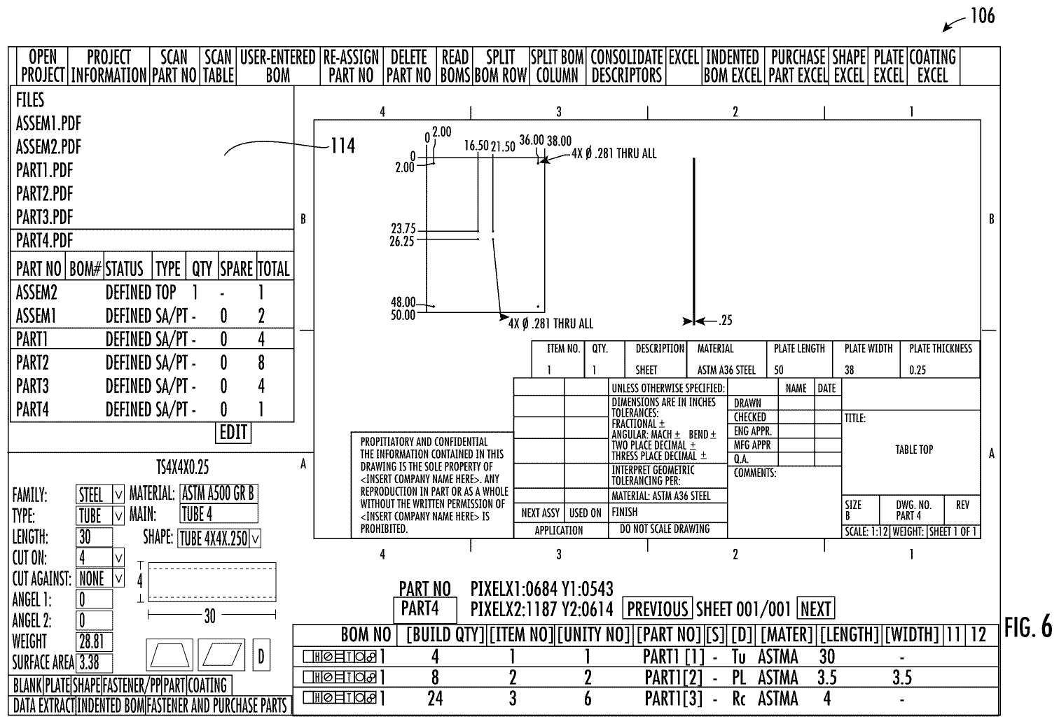

Referring now to FIG. 6, the step of the user 105 defining each row is described with reference to the GUI 106. Here, after all rows have been defined, an algorithm reformats the data in the drawing tree 114. The drawing tree 114 collapses and status changes to “Defined”. After all parts on the left side of the drawing tree 114 have been defined, the user 105 can then export the purchase information. Although the depicted GUI 106 includes annotations from the user 105, it should be appreciated that in some embodiments, these annotations may be automated and user input omitted.

In the following, a description of an exemplary embodiment of the method for generating a BOM for an initial drawing 101 is provided. The method comprises scanning through the initial drawing 101 (e.g., a PDF package), extracting data, and assigning each extracted BOM to a part number. Computer Vision and optical character recognition (OCR) features may be required. The method also includes detecting key columns and rows to generate material purchase lists. In some embodiments, data science and recursive summation features may be used.

The method includes calculating mass and surface area of blueprint parts across the initial drawing 101. These will be used to calculate plating, paint, and powder coating. As will be appreciated, this step may include paint, powder coating, volume, and density formulations.

The method also includes extracting plate and sheet shapes from the initial drawing 101. In some embodiments, the method may use computer vision, geometry and calculus, and linear optimization. These are useful to order the minimal amount of stock length. The goal is to maximize utilization of each stock size. In particular, the following issues need to be addressed: the cutting stock problem, for cutting of 1D shapes on a saw or tube laser; the 2D guillotine cutting stock problem, for cutting 2D shapes on guillotine shear; and the 2D laser nesting problem, for cutting of 2D shapes on laser/waterjet.

The method also includes applying spare and pack sizing to purchased parts and automatically calculating the number of packs to order. The method comprises outputting CSV lists of: a number of stocks to order of plates/sheet; a number of stocks to order of structural shapes; gallons of paint and pounds of powder coating to order; a total number of purchase parts and fasteners to order; shipping manifests; a reformatted BOM list to standardize BOM presentation; an indented BOM/Drawing Tree (a type of document to represent BOM data); and an output of dimensioned PDF drawings of: saw and tube laser cut plans; shear, laser, and waterjet nesting plans.

In the table recognition and extraction step, some embodiments may require computer vision and OCR. The system 100 may analyze any initial drawing 101 and extract tabular data. The system 100 may recognize tabular data. The scanned PDFs introduce many imperfections including random pixelated gaps plus random noise throughout the pages. The system 100 will apply many image filters to ensure that tables are automatically recognized, but it will not alter text within the cells. After a table is identified, the cells are run through OCR one cell at a time. The filtering must not be too aggressive; otherwise, the OCR will fail, and bad text data will be extracted from the table.

The plate and sheet shape extraction step may use computer vision and mathematical theory. Plate and sheet are often cut on laser, plasma, and waterjet tables which require 2D Computer Aided Design (CAD) files to operate. The system 100 will extract this data from the PDF and scale to utilize as a CAD file. The system 100 may ignore data such as dimensional callouts, construction lines, and text to extract the plate and sheet CAD profiles. The system 100 correctly identifies circles, arcs, splines, and lines. Ensuring that these CAD files are accurate will be challenging after scaling as the CAD must be accurate with 30 thousandths of an inch or less. Gap analysis must be considered to ensure all contours are closed as unclosed contours will not work. These CAD files will also be utilized to solve the cutting stock problems discussed in the next paragraph.

The solving of the cutting stock problems has been historically very challenging Linear Algebra Mixed Integer Problems (MIP) to solve. There are several methods to solve including column generation, arc flow, genetic algorithms, etc. The system 100 minimizes the amount of stock material ordered. In addition, each stock piece should be packed as efficiently as possible to minimize waste. Keeping runtime down will be an issue here as these problems require a lot of time to solve.

The data analysis and manipulation step may be complex. The PDF drawings created by thousands of potential customers on various CAD software have infinite styles and methods of presenting data. The system 100 must have robust functions to deal with any customer or CAD drawing style while remaining easy to use for the user.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. A system for extracting data from a drawing Bill of Materials (BOM), the system comprising:
a processor and memory associated therewith and configured to
receive an initial drawing,
process to extract data from the drawing BOM to generate a plurality of extracted values,
assign a part number to each of the plurality of extracted values,
generate a material list based upon the part numbers for the plurality of extracted values,
generate a plurality of area values and a plurality of mass values for the material list,
generate a value for stock material from the initial drawing, and
output a listing for the BOM based upon the material list and the value for stock material.

2. The system of claim 1 wherein the processor is configured to extract data listed for every component from the drawing BOM and assign it a part number and a part category for each component.

3. The system of claim 1 wherein the processor is configured to receive annotations input from a user related to the plurality of extracted values and the plurality of area values.

4. The system of claim 3 wherein the annotations comprises annotations for BOMs in part drawings.

5. The system of claim 1 wherein the processor is configured to scan in text directly from the initial drawing.

6. The system of claim 1 wherein the processor is configured to calculate weight and surface area of each part, and calculate estimated paint usage of each part.

7. The system of claim 1 wherein the listings comprises at least one of a reformatted BOM list, an indented BOM List, a part list, a purchase list including quantity of stock lengths of structural shapes, quantity of stock plates/sheet, and quantity of purchase parts/fasteners needed, a purchase part and fastener kitting lists and labels, plate nesting lists, structural shape nesting lists, paint lists, and shipping lists.

8. The system of claim 1 wherein the processor is configured to render a graphics user interface (GUI) comprising a part number selection menu where a user identifies a part, and a table selection menu where the user selects a scan table.

9. The system of claim 1 wherein the processor is configured to preprocess images of the initial drawings.

10. The system of claim 9 wherein the processor is configured to preprocess the images of the initial drawings based upon an optical character recognition (OCR) process.

11. A method for extracting data from a drawing Bill of Materials (BOM), the method comprising:
receiving an initial drawing;
processing the initial drawing to generate a plurality of extracted values;
assigning a part number to each of the plurality of extracted values;
generating a material list based upon the part numbers for the plurality of extracted values;
generating a plurality of area values and a plurality of mass values for the material list;
generating a value for stock material from the initial drawing; and
outputting a listing for the BOM based upon the material list and the value for stock material.

12. The method of claim 11 further comprising extracting data listed for every component from the drawing BOM and assign it a part number and a part category for each component.

13. The method of claim 11 further comprising receiving annotations input from a user related to the plurality of extracted values and the plurality of area values.

14. The method of claim 13 wherein the annotations comprises annotations for BOMs in part drawings.

15. The method of claim 11 further comprising scanning in text directly from the initial drawing.

16. The method of claim 11 further comprising calculating weight and surface area of each part, and calculate estimated paint usage of each part.

17. The method of claim 11 wherein the listings comprises at least one of a reformatted BOM list, an indented BOM List, a part list, a purchase list including quantity of stock lengths of structural shapes, quantity of stock plates/sheet, and quantity of purchase parts/fasteners needed, a purchase part and fastener kitting lists and labels, plate nesting lists, structural shape nesting lists, paint lists, and shipping lists.

18. The method of claim 11 further comprising rendering a graphics user interface (GUI) comprising a part number selection menu where a user identifies a part, and a table selection menu where the user selects a scan table.

19. The method of claim 11 further comprising preprocessing images of the initial drawings.

20. The method of claim 19 further comprising preprocessing the images of the initial drawings based upon an optical character recognition (OCR) process.
